(19) United States
(12) Patent Application Publication
(10) Pub. No.: US 2005/0041820 A1
(43) Pub. Date: Feb. 24, 2005

(54) Method of mounting and driving speakers

(75) Inventors: Yasuhisa Abe, Yamagata-ken (JP); Takayuki Negishi, Yamagata-ken (JP); Takeshi Ito, Yamagata-ken (JP); Katsuhiro Sasaki, Yamagata-ken (JP); Toshihiro Hikichi, Yamagata-ken (JP); Hiroyuki Hamada, Saitama-ken (JP); Shintaro Hosoi, Saitama-ken (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignees: Pioneer Corporation; Tohoku Pioneer Corporation

(21) Appl. No.: 10/919,283

(22) Filed: Aug. 17, 2004

(30) Foreign Application Priority Data
Aug. 18, 2003 (JP) 2003-207715

(51) Int. Cl. H04R 5/02; H04R 1/02

(52) U.S. Cl. 381/86; 381/302; 381/389

(57) ABSTRACT

First auxiliary speakers are mounted in the vehicle-passenger space with respect to main speakers providing for acoustic reproduction in the vehicle-passenger space. The first auxiliary speakers output sound in the same frequency band as that of sound outputted from the main speakers. Acoustic outputs of the first auxiliary speakers are set to make a sound pressure of the sound reaching a listener sit in the vehicle-passenger space from the first auxiliary speakers nearly equal to a sound pressure of the sound reaching the listener from the main speakers.

### BACKGROUND OF THE INVENTION

1. Field of the Invention

This invention relates to a method of mounting and driving speakers that reproduce sound in an enclosed space.

The present application claims priority from Japanese Application No. 2003-207715, the disclosure of which is incorporated herein by reference.

2. Description of the Related Art

In most cases, audio apparatuses provide the required sound effect by the use of a set or sets of speakers to produce output for each frequency band divided.

When such an audio apparatus is mounted on, e.g., a vehicle, as illustrated in FIG. 1, a portion of the sound s reproduced from each speaker SP is reflected off a wall face 1A and/or the like of the passenger space 1 which is a small enclosed space, and then reaches the ears of the listener (e.g. driver) L who sits at a listening point (e.g. the driver's seat in FIG. 1). Because of this, the acoustic characteristics inherent in the passenger space 1 occur to make it difficult to provide the original sound field.

Therefore, one of the conventional suggestions is a system of automatically correcting the frequency characteristics of a vehicle-mounted audio apparatus in which the frequency characteristics are automatically corrected based on the audio signal obtained from a microphone located at a listening point in order to reproduce the original sound field in the passenger space of the vehicle.

Such a conventional automatic frequency-characteristics correction system for a vehicle-mounted audio apparatus is described in Japanese Unexamined Patent Publication No. 9-65483.

However, when this automatic frequency-characteristics correction system is fitted in an audio apparatus of reproducing sound in a small enclosed space, such as a vehicle-mounted audio apparatus, this system needs a complicated structure, which then causes an increase in the price of products. Further the complicated structure needs intricate adjustment, so that the system is not necessarily capable of providing the required effect.

### SUMMARY OF THE INVENTION

A technical problem of the present invention is to solve the problems associated with the conventional audio apparatus when reproducing sound in any enclosed space as described above.

It is accordingly an object of the present invention to provide a method of mounting and driving speakers capable of reproducing an original sound field in an enclosed space.

To attain this object, in the present invention, auxiliary speakers are mounted in an enclosed space with respect to main speakers providing for acoustic reproduction in the enclosed space. The auxiliary speakers output sound in the same frequency band as that of sound outputted from the main speakers. Acoustic outputs of the auxiliary speakers are set to make a sound pressure of the sound reaching a listening position in the enclosed space from the auxiliary speakers nearly equal to a sound pressure of the sound reaching the listening position from the main speakers.

In this method of mounting and driving the speakers, auxiliary speakers, in addition to the main speakers, are arranged within a relatively small enclosed space such as the passenger space of a vehicle. The frequency band of the sound reproduced from the auxiliary speaker is set equal to the frequency band of the sound reproduced from the main speaker. In addition, the acoustic output of the auxiliary speaker is set such that the sound pressure of the sound coming from the auxiliary speaker to a listening position in the enclosed space becomes approximately equal to the sound pressure of the sound coming from the main speaker to the listening position. Hence, these factors reduce any influence resulting from the correlation between the sound reaching the listening position directly from the main speakers and the reflected sound reaching the listening position after being reflected in the enclosed space. By this means, the interactions of the sounds in the enclosed space with each other are able to be substantially and mutually cancelled. Thus, any occurrence of the acoustic characteristics inherent in the space configuration inside the enclosed space is restricted to make it possible to reproduce the original sound field.

With this method of mounting and driving the speakers, the mere placement of the speakers and adjustment of the acoustic outputs make it possible to provide the desired effect. Thus, the price of product will not be significantly increased.

These and other objects and features of the present invention will become more apparent from the following detailed description with reference to the accompanying drawings.

### BRIEF DESCRIPTION OF THE DRAWINGS

FIG. 1 is a diagram illustrating a conventional form of reproducing sound in a vehicle-passenger space.

FIG. 2 is a layout diagram of auxiliary speakers in a first embodiment according to the present invention.

FIG. 3 is a layout diagram of auxiliary speakers in a second embodiment according to the present invention.

FIG. 4 is a layout diagram of auxiliary speakers in a third embodiment according to the present invention.

FIG. 5 is a layout diagram of auxiliary speakers in a fourth embodiment according to the present invention.

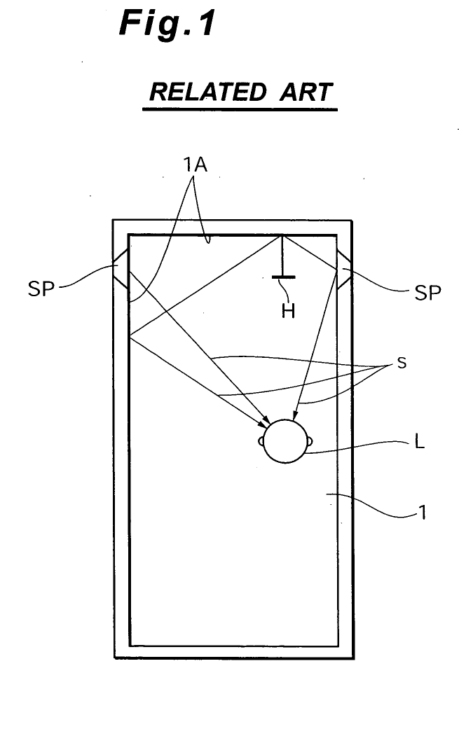

### DETAILED DESCRIPTION OF THE PREFERRED EMBODIMENTS

Some of the preferred embodiments according to the present invention will be described below in detail with reference to the accompanying drawings.

The present invention is able to be applied to any of various types of speakers for reproducing sound in an enclosed space of a relatively small capacity. However, for illustration purposes, speakers used for reproducing sound in the passenger space of a vehicle will be described hereinafter.

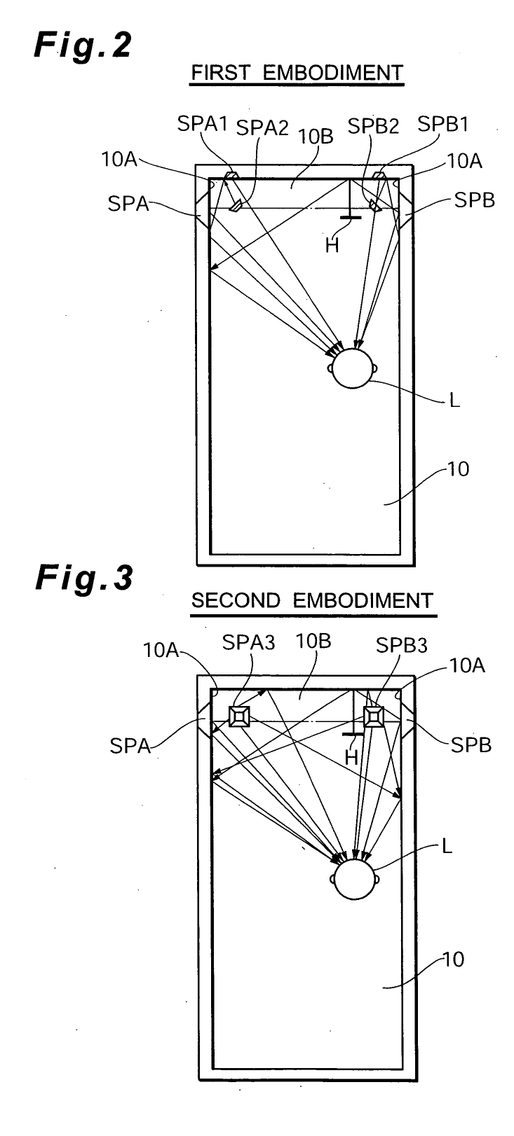

FIG. 2 illustrates an example of a speaker layout in a first embodiment according to the present invention.

In FIG. 2, a set of main speakers SPA, SPB is mounted on the front right and left side walls 10A respectively (i.e. the portions of the side walls on opposite sides of the steering wheel H in FIG. 2) inside the passenger space 10.

A set of first auxiliary speakers SPA1, SPB1 is mounted on the right and left hands of the front portion 10B respectively (e.g. on the dashboard or in the vicinity of the kick panel) inside the passenger space 10 to face toward the rear of the vehicle (i.e. the inward direction of the vehicle).

Further, a set of second auxiliary speakers SPA2, SPB2 is installed respectively in positions opposite to the first auxiliary speakers SPA1, SPB1 on the front portion (e.g. on the dashboard or in the vicinity of the kick panel) inside the passenger space 10 to face toward the front of the vehicle (i.e. the direction opposite to the inside of the vehicle).

The following describes a method of driving the first auxiliary speakers SPA1, SPB1 and the second auxiliary speakers SPA2, SPB2 that are arranged in the above manner.

The acoustic outputs from the first auxiliary speakers SPA1, SPB1 and the second auxiliary speakers SPA2, SPB2 are identical in frequency band with the acoustic outputs from the corresponding main speakers SPA, SPB.

A power amplifier (not shown) of the audio apparatus connected to the first auxiliary speakers SPA1, SPB1 undergoes output adjustment in such a manner that the sound pressures of the sounds coming directly from the first auxiliary speakers SPA1, SPB1 to the listener (e.g. the driver in FIG. 2) L positioned at the listening point (e.g. the driver's seat in FIG. 2) become respectively equal to the sound pressures of the sounds coming directly from the main speakers SPA, SPB to the listener L.

Another power amplifier (not shown) of the audio apparatus connected to the second auxiliary speakers SPA2, SPB2 undergoes output adjustment in such a manner that the sound pressures of the sounds reaching the listener L by being reflected by the front portion (e.g. the front windscreen and the like) of the passenger space 10 after being outputted from the second auxiliary speakers SPA2, SPB2 become respectively equal to the sound pressures of the sounds reaching the listener L directly from the main speakers SPA, SPB.

Regarding the acoustic signals to be inputted to the first auxiliary speakers SPA1, SPB1 and the second auxiliary speakers SPA2, SPB2, Lch signals may be inputted to the left speakers SPA1, SPA2 and Rch signals may be inputted to the right speakers SPB1, SPB2, in the usual way. Further, after checking the effects of the sound field produced, the Rch signals may be inputted to the left speakers SPA1, SPA2 and the Lch signals may be inputted to the right speakers SPB1, SPB2.

As described hitherto, in the first embodiment, the first auxiliary speakers SPA1, SPB1 and the second auxiliary speakers SPA2, SPB2 are arranged in the front portion of the passenger space 10 in which the main speakers SPA, SPB are located. Output from each of the auxiliary speakers is adjusted to reduce any influence resulting from the correlation between the sound reaching the listener directly from the main speakers SPA, SPB and the reflected sound reaching the listener L after being reflected in the passenger space 10. By this means, the interactions of the sounds in the passenger space 10 with one another are able to be substantially and mutually cancelled. Thus, any occurrence of the acoustic characteristics inherent in the space configuration inside the passenger space 10 is restricted to make it possible to reproduce the original sound field.

FIG. 3 illustrates an example of a speaker layout in a second embodiment according to the present invention.

In FIG. 3, as in the case of the first embodiment, a set of main speakers SPA, SPB is mounted on the front right and left side walls 10A respectively (i.e. the portions of the side walls on opposite sides of the steering wheel H in FIG. 3) in the passenger space 10.

A set of polyhedral and nondirectional auxiliary speakers SPA3, SPB3 is mounted on the right and left hands of the front portion (e.g. the dashboard) 10B inside the passenger space 10.

The following describes a method of driving the polyhedral and nondirectional auxiliary speakers SPA3, SPB3.

The acoustic outputs from the auxiliary speakers SPA3, SPB3 are identical in the frequency band with the acoustic outputs from the main speakers SPA, SPB, respectively.

A power amplifier (not shown) of the audio apparatus connected to the auxiliary speakers SPA3, SPB3 undergoes output adjustment in such a manner that the sound pressures of the sounds coming directly from the auxiliary speakers SPA3, SPB3 to the listener L (e.g. the driver in FIG. 3) positioned at the listening point (e.g. the driver's seat in FIG. 3) and the sound pressures of the sounds reaching the listener L after being reflected by the front portion (e.g. the front windscreen and the like) of the passenger space 10 become respectively equal to the sound pressures of the sounds reaching the listener L directly from the main speakers SPA, SPB.

Regarding the acoustic signals to be inputted to the auxiliary speakers SPA3, SPB3, an Lch signal may be inputted to the left speaker SPA3 and an Rch signal may be inputted to the right speaker SPB3 in the usual way. Further, after checking the effects of the sound field produced, the Rch signal may be inputted to the left speaker SPA3 and the Lch signal may be inputted to the right speaker SPB3.

Alternatively, the input to one portion of the polyhedron may be produced in the usual way, and the input to other portions of the polyhedron may be produced by means of a change of places between Lch and Rch.

As described hitherto, in the second embodiment, the auxiliary speakers SPA3, SPB3 are arranged in the front portion of the passenger space 10 in which the main speakers SPA, SPB are located. Output from each of the auxiliary speakers is adjusted to reduce the influence resulting from the correlation between the sound directly reaching the listener L from the main speakers SPA, SPB and the reflected sound reaching the listener L after being reflected in the passenger space 10. By this means, the interactions of the sounds in the passenger space 10 with each other are able to be substantially and mutually cancelled. Thus, any occurrence of the acoustic characteristics inherent in the space configuration inside the passenger space 10 is restricted to make it possible to reproduce the original sound field.

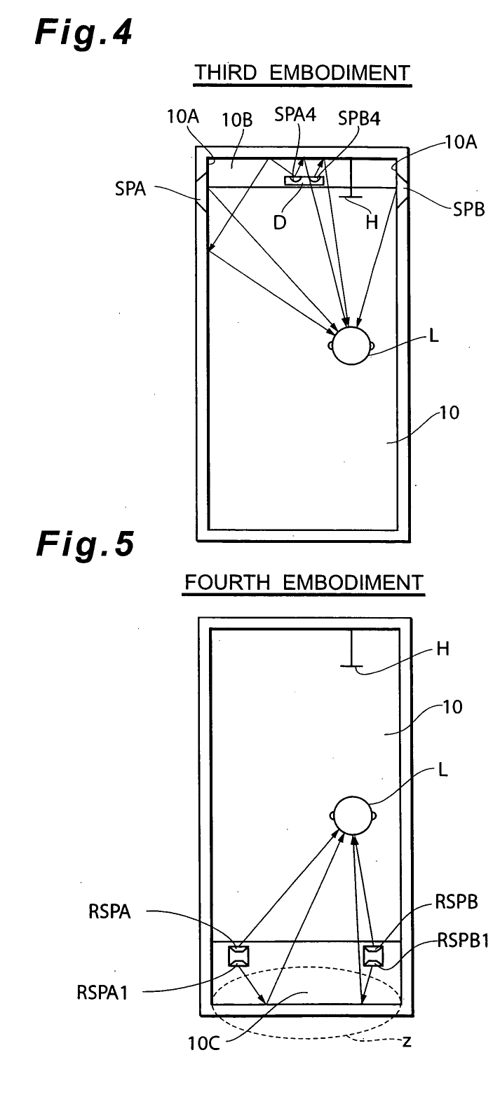

FIG. 4 illustrates an example of a speaker layout in a third embodiment according to the present invention.

In FIG. 4, as in the case of the first embodiment, a set of main speakers SPA, SPB is mounted on the front right and left side walls 10A respectively (i.e. the portions of the side walls on opposite sides of the steering wheel H in FIG. 4) in the passenger space 10.

A set of speakers SPA4, SPB4 is mounted on the right and left hands of the rear surface of a display D of a car navigation system or the like that is mounted substantially in a central portion of the front portion (e.g. on the dashboard) 10B inside the passenger space 10. The speakers SPA4, SPB4 face toward the front of the vehicle (i.e. toward the front windscreen).

The following describes the method of driving the auxiliary speakers SPA4, SPB4.

The acoustic outputs from the auxiliary speakers SPA4, SPB4 are identical in the frequency band with the acoustic outputs from the main speakers SPA, SPB.

A power amplifier (not shown) of the audio apparatus connected to the auxiliary speakers SPA4, SPB4 undergoes output adjustment in such a manner that the sound pressures of the sounds reaching the listener L (e.g. the driver in FIG. 4) positioned at the listening point (e.g. the driver's seat in FIG. 4) from the auxiliary speakers SPA4, SPB4 after being reflected off the front portion of the passenger space 10 (e.g. the front windscreen and the like) become equal to the sound pressures of the sounds reaching the listener L directly from the main speakers SPA, SPB.

Regarding the acoustic signals to be inputted to the auxiliary speakers SPA4, SPB4, an Lch signal may be inputted to the left speaker SPA4 and an Rch signal may be inputted to the right speaker SPB4 in the usual way. Further, after checking the effects of the sound field produced, the Rch signal may be inputted to the left speaker SPA4 and the Lch signal may be inputted to the right speaker SPB4.

As described hitherto, in the third embodiment, the auxiliary speakers SPA4, SPB4 are arranged in the front portion of the passenger space 10 in which the main speakers SPA, SPB are located. Output from each of the auxiliary speakers is adjusted to reduce the influence resulting from the correlation between the sound reaching the listener L directly from the main speakers SPA, SPB and the reflected sound reaching the listener L after being reflected in the passenger space 10. By this means, the interactions of the sounds in the passenger space 10 with each other are able to be substantially and mutually cancelled. Thus, any occurrence of the acoustic characteristics inherent in the space configuration inside the passenger space 10 is restricted to make it possible to reproduce the original sound field.

FIG. 5 illustrates an example of a speaker layout in a fourth embodiment according to the present invention.

Unlike each of the cases of the first, second and third embodiments, FIG. 5 illustrates an example when the present invention is applied to rear speakers in a multi-channel speaker system.

In FIG. 5, a set of rear speakers RSPA, RSPB in a multi-channel speaker system such as a 5.1 channel system is mounted on the right and left hands on the board 10C situated behind the rear seat of the passenger space 10. The rear speakers RSPA, RSPB face toward the front (i.e. toward the inside of the passenger space 10).

A set of auxiliary rear speakers RSPA1, RSPB1 is mounted to face toward the rear (i.e. toward the rear window). The auxiliary rear speakers RSPA1, RSPB 1 are located back to back with the rear speakers RSPA, RSPB, respectively.

The following describes the method of driving the auxiliary rear speakers RSPA1, RSPB1.

The acoustic outputs from the auxiliary rear speakers RSPA1, RSPB1 are identical in the frequency band with the acoustic outputs from the rear speakers RSPA, RSPB, respectively.

A power amplifier (not shown) of the audio apparatus connected to the auxiliary rear speakers RSPA1, RSPB1 undergoes output adjustment in such a manner that the sound pressures of the sounds reaching the listener L (e.g. the driver in FIG. 5) positioned at the listening point (e.g. the driver's seat in FIG. 5) after being outputted from the auxiliary rear speakers RSPA1, RSPB1 and then reflected off the rear portion of the passenger space 10 (e.g. the rear window and the like) become equal to the sound pressures of the sounds reaching the listener L directly from the rear speakers RSPA, RSPB.

For example, the acoustic output from the auxiliary rear speakers RSPA1, RSPB1 may be set in the order of 3 dB lower than the acoustic output from the rear speakers RSPA, RSPB.

Regarding the acoustic signals to be inputted to the auxiliary rear speakers RSPA1, RSPB1, an Lch signal may be inputted to the left speaker RSPA1 and an Rch signal may be inputted to the right speaker RSPB1 in the usual way, and the same signal may be inputted to the back-to-back rear speakers RSPA and RSPA1 and to the back-to-back rear speakers RSPB and RSPB1. Alternatively, an Rch signal may be inputted to the left speaker RSPA1 and an Lch signal may be inputted to the right speaker RSPB1. A signal opposite to that of the rear speaker RSPA located back to back with the auxiliary rear speaker RSPA1 is inputted to the speaker RSPA1, and likewise a signal opposite to that of to the rear speaker RSPB located back to back with the auxiliary rear speaker RSPB1 is inputted to the speaker RSPB1.

As described hitherto, in the fourth embodiment, the auxiliary rear speakers RSPA1, RSPB1 are arranged in the rear portion of the passenger space 10 in which the rear speakers RSPA, RSPB of the multi-channel speaker system are located. Output from each of the auxiliary rear speakers is adjusted to reduce the influence resulting from the correlation between the sound directly reaching the listener L from the rear speakers RSPA, RSPB and the reflected sound reaching to the listener L after being reflected in the passenger space 10. By this means, the interactions of the sounds in the passenger space 10 with each other are able to be substantially and mutually cancelled. Thus, any occurrence of the acoustic characteristics inherent in the space configuration inside the passenger space 10 is restricted to make it possible to reproduce the original sound field, and additionally to enhance the perception of the spatial spread of a sound field z in the rear portion of the passenger space 10.

The method of mounting and driving the speakers described in each of the foregoing embodiments is based on a fundamental idea of a method of mounting and driving speakers that comprises the steps of: mounting auxiliary speakers in an enclosed space with respect to main speakers providing for acoustic reproduction in the enclosed space; outputting sound from the auxiliary speakers in the same frequency band as that of sound outputted from the main speakers; and setting acoustic outputs of the auxiliary speakers to make the sound pressure of the sound reaching a listening position in the enclosed space from the auxiliary speakers nearly equal to the sound pressure of the sound reaching the listening position from the main speakers.

In the method of mounting and driving the speakers based on this fundamental idea, auxiliary speakers, in addition to the main speakers, are arranged within a relatively small enclosed space such as the passenger space of a vehicle. The frequency band of the sound reproduced from the auxiliary speaker is set equal to the frequency band of the sound reproduced from the main speaker. In addition, the acoustic output of the auxiliary speaker is set such that the sound pressure of the sound coming from the auxiliary speaker to a listening position in the enclosed space becomes approximately equal to the sound pressure of the sound coming from the main speaker to the listening position.

Hence, these factors reduce any influence resulting from the correlation between the sound reaching the listening position directly from the main speakers and the reflected sound reaching the listening position after being reflected in the enclosed space. By this means, the interactions of the sounds in the enclosed space with each other are able to be substantially and mutually cancelled. Thus, any occurrence of the acoustic characteristics inherent in the space configuration inside the enclosed space is restricted to make it possible to reproduce the original sound field.

With this method of mounting and driving the speakers, the mere placement of the speakers and adjustment of the acoustic outputs make it possible to provide the desired effect, resulting in the prevention of a significant increase in the price of product.

The terms and description used herein are set forth by way of illustration only and are not meant as limitations. Those skilled in the art will recognize that numerous variations are possible within the spirit and scope of the invention as defined in the following claims.

1. A method of mounting and driving speakers, comprising the steps of:
mounting auxiliary speakers in an enclosed space with respect to main speakers providing for acoustic reproduction in the enclosed space;
outputting, from the auxiliary speakers, sound in the same frequency band as that of sound outputted from the main speakers; and
setting acoustic outputs of the auxiliary speakers to make a sound pressure of the sound reaching a listening position in the enclosed space from the auxiliary speakers nearly equal to a sound pressure of the sound reaching the listening position from the main speakers.

2. A method of mounting and driving speakers according to claim 1, wherein the enclosed space is a passenger space of a vehicle.

3. A method of mounting and driving speakers according to claim 1, wherein a set of the main speakers is arranged in right and left sides of a front portion of the enclosed space, and at least a set of the auxiliary speakers is arranged in positions between the set of the main speakers arranged in the front portion of the enclosed space, and attached to face toward the inside of the enclosed space.

4. A method of mounting and driving speakers according to claim 3, wherein a right channel acoustic signal and a left channel acoustic signal are switched between right and left and then inputted to the right-positioned and left-positioned speakers of the set of the auxiliary speakers.

5. A method of mounting and driving speakers according to claim 1, wherein a set of the main speakers is arranged in right and left sides of a front portion of the enclosed space, and at least a set of the auxiliary speakers is arranged in positions between the set of the main speakers arranged in the front portion of the enclosed space, and attached to face toward the front portion of the enclosed space.

6. A method of mounting and driving speakers according to claim 5, wherein a right channel acoustic signal and a left channel acoustic signal are switched between right and left and then inputted to the right-positioned and left-positioned speakers of the set of the auxiliary speakers.

7. A method of mounting and driving speakers according to claim 1, wherein the auxiliary speakers are of a polyhedral and nondirectional type.

8. A method of mounting and driving speakers according to claim 7, wherein a set of the main speakers is arranged in right and left sides of a front portion of the enclosed space, and at least a set of the polyhedral and nondirectional auxiliary speakers is arranged in positions between the set of the main speakers arranged in the front portion of the enclosed space.

9. A method of mounting and driving speakers according to claim 8, wherein a right channel acoustic signal and a left channel acoustic signal are switched between right and left and then inputted to either portions or all of the right-positioned and left-positioned speakers of the set of the polyhedral and nondirectional auxiliary speakers.

10. A method of mounting and driving speakers according to claim 1, wherein the auxiliary speakers are attached to portions of a rear surface of a display attached to a front portion of the enclosed space in a position facing toward the front of the enclosed space.

11. A method of mounting and driving speakers according to claim 10, wherein a set of the main speakers is arranged in right and left sides of the front portion of the enclosed space, and at least a set of the auxiliary speakers is attached to the rear surface of the display located in a position between the set of the main speakers.

12. A method of mounting and driving speakers according to claim 11, wherein a right channel acoustic signal and a left channel acoustic signal are switched between right and left and then inputted to the right-positioned and left-positioned speakers of the set of the auxiliary speakers.

13. A method of mounting and driving speakers according to claim 1, wherein the main speakers are rear speakers in a multi-channel speaker system.

14. A method of mounting and driving speakers according to claim 13, wherein a set of the main speakers is arranged in right and left sides of a rear portion of the enclosed space, and at least a set of auxiliary speakers is attached to face toward the rear portion of the enclosed space.

15. A method of mounting and driving speakers according to claim 14, wherein the set of main speakers and the set of auxiliary speakers are arranged back to back with each other.

16. A method of mounting and driving speakers according to claim 14, wherein a right channel acoustic signal and a left channel acoustic signal are switched between right and left and then inputted to the right-positioned and left-positioned speakers of the set of auxiliary speakers.

17. A method of mounting and driving speakers according to claim 14, wherein the acoustic outputs from the set of the auxiliary speakers are set approximately 3 dB lower than the acoustic output from the main speakers.
